(19) United States
(12) Patent Application Publication
(10) Pub. No.: US 2012/0205470 A1
(43) Pub. Date: Aug. 16, 2012

(54) METHOD FOR PRODUCING A FUEL INJECTION VALVE, AND FUEL INJECTION VALVE

(75) Inventors: Susanne Spindler, Stuttgart (DE); Stephan Amelang, Koenigsbach-Stein (DE); Matthias Burger, Murr (DE); Christian Faltin, Korntal-Muenchingen (DE); Hans-Christoph Magel, Reutlingen (DE)

(73) Assignee: ROBERT BOSCH GMBH, Stuttgart (DE)

(21) Appl. No.: 13/503,686

(22) PCT Filed: Oct. 1, 2010
(86) PCT No.: PCT/EP2010/064647

§ 371 Date: Apr. 24, 2012

(30) Foreign Application Priority Data
Nov. 10, 2009 (DE) 102009046582.0

(51) Int. Cl. F02M 47/02; F02M 61/10; B23P 17/00

(52) U.S. Cl. 239/585.5; 29/890.124; 29/890.131

(57) ABSTRACT

The invention relates to a method for producing a fuel injection valve (10; 10a; 60; 60a), in which a valve needle (40; 40a; 62; 62a) which closes at least one fuel outlet opening (49) is inserted into an injector housing (11), wherein that end of the valve needle (40; 40a; 62; 62a) which lies opposite the at least one fuel outlet opening (49) is guided in a valve element (32) which has a pressurized control chamber (37) which is filled with fuel, wherein the control chamber (37) can be closed on the side which faces away from the valve needle (40; 40a; 62; 62a) by a closing element (23) which forms a passage during opening and is connected at least indirectly to a fuel return line (5) which is under low pressure, wherein fuel volume which is present in the control chamber (37) flows away through the passage after opening of the control chamber (37) by means of the closing element (23), wherein the valve needle (40; 40a; 62; 62a) moves in the direction of the closing element (23), wherein the at least one fuel outlet opening (49) is opened, and wherein a delay time (t) occurs between the opening of the control chamber (37) and the opening of the at least one fuel outlet opening (49) on account of the magnitude of the volume of the control chamber (37) and on account of the rigidity of the valve needle (40; 40a; 62; 62a), which rigidity is caused by the modulus of elasticity, the diameter (D) and the length (L) of the valve needle (40; 40a; 62; 62a). There is provision according to the invention for at least the volume of the control chamber (37) to be adapted in order to achieve identical delay times (t) in fuel injection valves (10; 10a; 60; 60a) having injector housings (11) of different length and valve needles (40; 40a; 62; 62a) of different length, in such a way that the volume of the control chamber (37) is reduced in order to shorten the delay time (t) and the volume of the control chamber (37) is increased in order to lengthen the delay time (t).

### BACKGROUND OF THE INVENTION

The invention relates to a method for producing a fuel injection valve.

A method of said type for producing a fuel injection valve (hereinafter also referred to, in part, as “injector”) is already generally known and is used in particular for fuel injection valves in so-called common rail injection systems. Here, lift-controlled common rail injectors are known in which the nozzle needle is servo-driven. As pressure setting means, use is made of piezo valves and magnet valves by means of which the servo circuit is controlled. For fast closure of the valve needle, a permanent low-pressure stage is often installed which exerts a permanent closing force on the valve needle. The disadvantage here is however the relatively large amount of leakage that occurs between the high-pressure side and the low-pressure side. Leakage inevitably leads to the requirement for a higher pump power in the common rail injection system, and therefore to losses in the efficiency of the system. This is a problem particularly at relatively high pressures.

For this reason, the most modern injectors for extremely high injection pressures (this means pressures in the region of approximately 2000 bar) are designed to exhibit low leakage by virtue of the low-pressure stage being dispensed with. As a result of the lack of the low-pressure stage, however, only small closing forces are available for the valve needle. As a result, the response time between the actuation of the valve needle and the start of injection is relatively short. The response time is dependent primarily on the stiffness of the valve needle. Specifically because said response time is short in the case of an injector without a low-pressure stage, even an extremely small change in needle stiffness leads to a significant shift in the start of injection and change in the injected fuel quantity. The stiffness of the valve needle is dependent on the diameter and the length of the valve needle. If it is sought to design injectors of different structural length to have equal response times, it is necessary to realize corresponding waisting or diameter variation of the valve needle for each type or each length of injector. In this way, it is possible for the stiffness of the valve needles to be made consistent for all injectors. This however results in relatively long machine set-up times. A variation of only the needle length, with the needle diameter being equal for all injector structural lengths, would be ideal. This is however not possible owing to the resulting differences in the stiffness of the valve needle.

### SUMMARY OF THE INVENTION

Taking the presented prior art as a starting point, it is the object of the invention to further develop a method for producing a fuel injection valve such that the response time is at least substantially constant in fuel valves of different structural length or with different lengths of valve needle. Said object is achieved with a method for producing a fuel injection valve. Here, the invention is based on the concept of compensating for the different mechanical stiffness owing to different lengths of the valve needles by means of a variation of the “hydraulic stiffness” of the control chamber which is operatively connected to the valve needle. The underlying knowledge here is that, the larger the volume in the control chamber, the longer the delay or the response time until the opening of the injection orifices. In other words, this means that a relatively short and therefore stiff valve needle is compensated for by virtue of said valve needle being placed in operative connection with a control chamber which has a relatively large storage volume for fuel, and vice versa.

To permit particularly economical production of the fuel injection valve in which always the same valve piece with always the same recess for the control chamber can be used, it is proposed in one embodiment of the invention, which is particularly advantageous from a construction aspect, that the geometry of the control chamber in the region in which the valve needle is guided is in the form of a cylindrical bore with always the same diameter and always the same depth, and that the volume of the control chamber is adapted by means of a shortening or lengthening of that portion of the valve needle which is guided in the control chamber.

If a variation of the length of that portion of the valve needle which is guided in the control chamber is not sufficient to obtain the desired actuation time of the fuel injection valve, it is provided in a further refinement, which is particularly advantageous from a construction aspect, that the valve needle is composed of at least a standardized first portion arranged in the control chamber, which first portion is connected, on the side facing away from the control chamber, to a second cylindrical portion, and that the diameter of the second portion of the valve needle is varied such that, to shorten the delay time, the diameter of the valve needle is increased and, to lengthen the delay time, the diameter of the valve needle is decreased.

Here, to limit the number of possible different diameters of the valve needles, it is particularly advantageous if the diameter of the valve needle is varied in diameter steps, and if fine adjustment of the delay time is carried out by means of an adaptation of the volume of the control chamber by means of a variation of the length of the second cylindrical portion. A combination of a valve needle of a certain diameter with a valve needle of a certain length hereby takes place, in such a way that that portion of the standardized first portion which projects into the control chamber forms a certain control volume.

Furthermore, it is particularly advantageous if, taking into consideration the minimum and maximum possible volume of the control chamber and the available diameter steps of the valve needle, that valve needle diameter is selected which leads to a minimum volume of the control chamber. This means that always that valve needle which has the smallest diameter is selected. The further adaptation of the delay time is thereby realized by means of a lengthening or shortening of the valve needle.

Furthermore, the fuel valves can be produced particularly economically if the second portion of the valve needle is connected, on the opposite side from the standardized first portion, to a standardized third portion.

The connection between at least the second portion of the valve needle and the standardized first portion and if appropriate between the second portion of the valve needle and the third portion is realized preferably by laser welding. In this way it is possible to produce high-strength connections in a relatively economical manner.

Fuel valves produced in accordance with the method according to the invention can be produced particularly economically with regard to their structural length if the injector housing of the fuel injection valve has a standardized upper part with the closing element, with an actuating mechanism for the closing element and if appropriate with the valve piece, and a standardized lower part with a nozzle body, and if a central part which determines the overall structural length of the injector housing is arranged between the upper part and the lower part.

### BRIEF DESCRIPTION OF THE DRAWINGS

Further advantages of the method according to the invention for producing a fuel injection valve, and of the fuel injection valve, will emerge from the following description of preferred exemplary embodiments and on the basis of the drawings, in which:

FIGS. 1 and 2 show first fuel injection valves according to the invention, in which the injector housing thereof has a maximum structural length and a minimum structural length respectively, in each case in longitudinal section, and

FIGS. 3 and 4 show second fuel injection valves according to the invention, in which the injector housing has a maximum overall length and a minimum overall length respectively, likewise in longitudinal section.

Identical components or components of identical function are provided with the same reference numerals in the figures.

### DETAILED DESCRIPTION

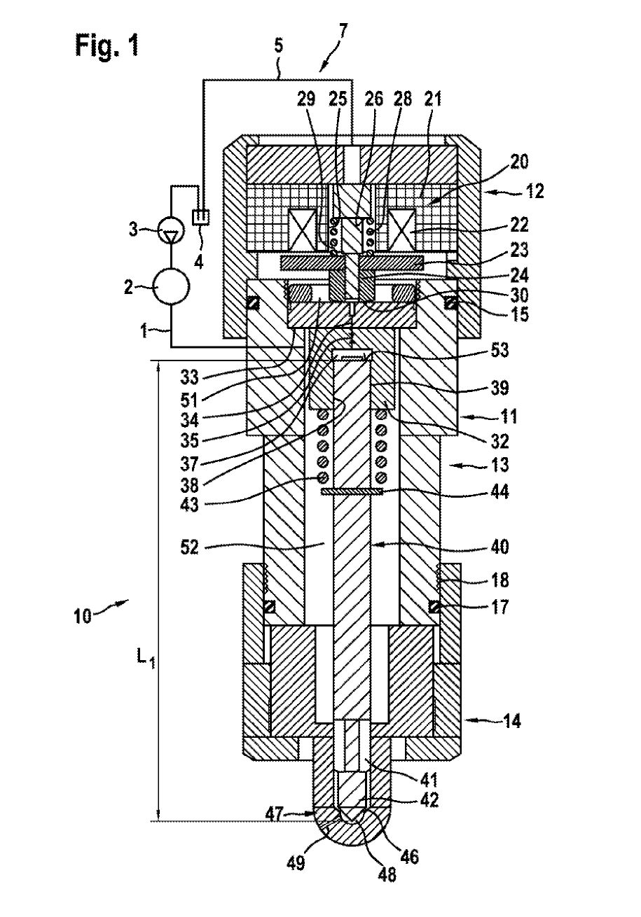

FIG. 1 illustrates a first fuel injection valve 10, such as is used in particular in so-called common rail injection systems. Here, the fuel injection valve 10 is connected via a supply line 1 to a fuel accumulator, a so-called rail 2. Fuel at high pressure, for example a pressure of approximately 2000 bar, is stored in the rail 2. Here, the rail 2 is connected to a high-pressure fuel pump 3 which sucks fuel out of a fuel store, in particular a fuel tank 4, and compresses said fuel. Fuel not required by the fuel injection valve 10 is returned to the fuel tank 4 again via a return line 5 which is at low pressure.

A fuel injection system 7 as described has a separate fuel injection valve 10 for each cylinder of an internal combustion engine, which fuel injection valves are all connected to the rail 2.

The fuel injection valve 10 has an injector housing denoted as a whole by 11. Here, the elongate injector housing 11 is composed of three assemblies: a standardized upper part 12, a central part 13 which is dependent on the structural length of the fuel injection valve 10 and which is in particular of annular design and formed if appropriate with different diameters, and a likewise standardized lower part 14. Between the upper part 12 and the central part 13 there is inserted into a seal groove a sealing ring 15, wherein the pressure-tight connection between the central part 13 and the upper part 12 is realized for example by means of an encircling laser weld or by means of an encircling flanged portion. In contrast, between the central part 13 and the lower part 14, with the interposition of a sealing ring 17, there is formed for example a screw connection 18 for connecting the central part 13 to the lower part 14 in a pressure-tight manner.

A pressure-balanced magnet valve 20 is inserted or arranged in the upper part 12, which magnet valve has a magnet core 21 and also a magnet coil 22 arranged in the magnet core 21. The magnet valve 20 furthermore has a magnet armature 23 which acts as a closing element and which is guided in an axially movable manner in a pin-shaped guide member 24. The guide member 24 is arranged in a through bore 25 of the magnet core 21 and has a step 26 between which and the facing side of the magnet armature 23 is supported a compression spring 28. Here, the compression spring 28 is arranged in a spring chamber 29 which, like the region of the upper part 12, in which the magnet core 21 is situated, is connected at least indirectly to the return line 5 and therefore to low pressure.

In the de-energized state of the magnet coil 22, the magnet armature 23 is pressed against a seat 30 of a valve piece 32. Here, the valve piece 32 is screwed into an upper portion of the central part 13, and here, is seated on a step 33 of the central part 13. A through bore 34 with an outflow throttle 35 is arranged in the longitudinal axis of the valve piece 32. The outflow throttle 35 is connected to a control chamber 37 which is formed as a blind bore 38 on the opposite side of the valve piece 32 from the magnet armature 23. On the open end side opposite from the outflow throttle 35, there projects into the blind bore 38 a first guide portion 39 of a valve needle 40.

The valve needle 40, which is of substantially cylindrical design, has on its opposite end from the valve piece 32 a second guide portion 41 which adjoins a valve tip 42. The valve tip 42 is pressed against a seat 46 of a nozzle body 47 by means of a compression spring 43 which is supported between a collar 44 of the valve needle 40 and the facing end surface of the valve piece 32. The seat 46 delimits a nozzle chamber 48 into which opens at least one through bore which serves as a fuel outlet orifice 49. Here, the nozzle body 47 is inserted into the lower part 14 of the injector housing 11.

The function of the fuel injection valve 10 as described is generally known and will therefore be explained only briefly, as follows: in the de-energized state of the magnet valve 20, the magnet armature 23 is pressed by the force of the compression spring 28 against the seat 30, such that the control chamber 37 is closed. Furthermore, the valve needle 40 is pressed by means of the compression spring 43 against the seat 46, such that the fuel outlet orifice 49 is also closed. When the magnet valve 20 or the magnet coil 22 is energized, the magnet armature 23 is raised from the seat 30, such that a passage is created from the control chamber 37, which is under high fuel pressure, to an armature chamber 51 which is connected to the return line 5. The flow of the fuel out of the control chamber 37 has the effect that the valve needle 40 is raised from its seat 46, and fuel flows from the high-pressure chamber 52, which is subjected to high pressure via the supply line 1, and from the nozzle chamber 48 out of the fuel injection valve 10 through the fuel outlet orifice 49, and is discharged into the combustion chamber of the internal combustion engine.

The valve needle 40 has a certain stiffness based on its length L₁, its material and therefore its modulus of elasticity, and its cross-sectional area A. In the de-energized state of the magnet valve 20, the valve needle 40 is pressed against the seat 46, wherein an elastic deformation of the valve needle 40 occurs owing to the above-described material properties and the geometry of the valve needle 40. When the magnet coil 20 is energized, and upon the associated pressure drop in the control chamber 37, the lifting of the valve needle 40 from the seat 46 takes place only when the pressure prevailing at the upper end surface 53 of the valve needle 40 or the corresponding axial force has decreased to such an extent that the valve needle 40 assumes its original length again. It is at the same time pointed out that the pressure drop in the control chamber 37, that is to say the period of time between the lifting of the magnet armature 23 from the seat 30 and the reduction in the axial force at the end surface 53, takes a certain period of time which is dependent on the size of the volume of the control chamber 37. The sum of the delays, resulting firstly from the pressure drop in the control chamber 37 and secondly from the elastic deformation of the valve needle 40, is referred to as the delay time or actuation time t.

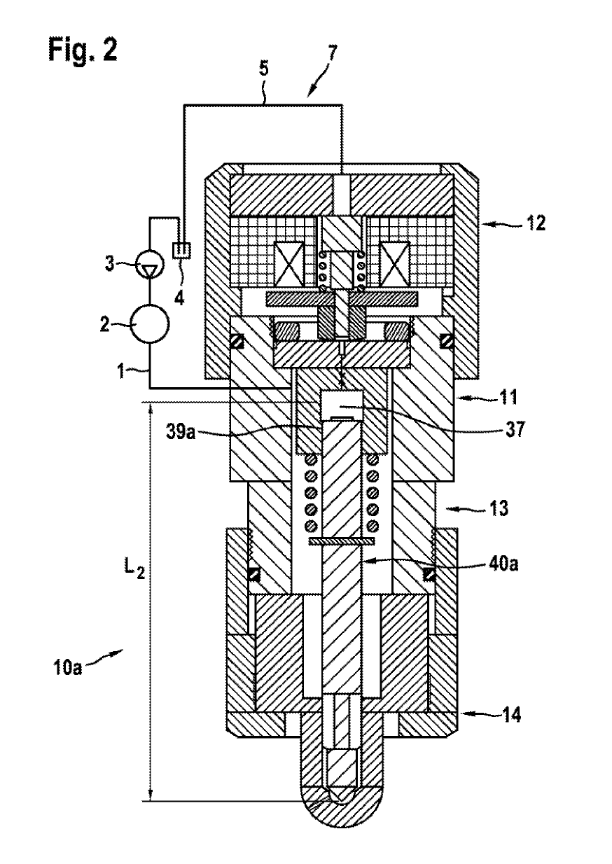

FIG. 2 illustrates a fuel injection valve 10a which differs from the fuel injection valve 10 illustrated in FIG. 1 in that it has a smaller structural length. It is provided according to the invention that the smaller structural length is realized by means of a decrease in size, or shortening, of the central part 13, while the lower part 14 and the upper part 12 are formed in each case as standardized components which are provided in identical form both in the fuel injection valve 10 and also in the fuel injection valve 10a. At the same time, the other components which are not arranged so as to be in direct operative connection with the central part 13 and with the valve needle 40 are also provided in identical form. The fuel injection valve 10a thus differs from the fuel injection valve 10 merely by the length of the central part 13 and by the length of the valve needle 40a. Since the length L₂ of the valve needle 40a, like the length of the central part 13, is shorter in relation to that in the fuel injection valve 10, the fuel injection valve 10a has a shorter response time with regard to the valve needle 40a, because (assuming that the valve needle 40 and the valve needle 40a are composed of the same material and have the same cross-sectional area A) the length L₂ of the valve needle 40a is shorter than the length L₁ of the valve needle 40. This would therefore likewise lead, overall, to a shortened actuation time t of the fuel injection valve 10a. To make the actuation times t both of the fuel injection valve 10 and also of the injection valve 10a equal, it is provided according to the invention that that part of the actuation time t which is influenced by the volume of the control chamber 37 be increased in the fuel injection valve 10a in relation to the fuel injection valve 10. This is realized by means of an enlargement of the volume of the control chamber 37 by virtue of the guide portion 39a, which projects into the control chamber 37, of the valve needle 40a being reduced in length. In other words, this means that the shortening of the actuation time t owing to the smaller length L₂ of the valve needle 40a is compensated for by means of an elongation of that part of the actuation time t which is based on the enlarged volume of the control chamber 37.

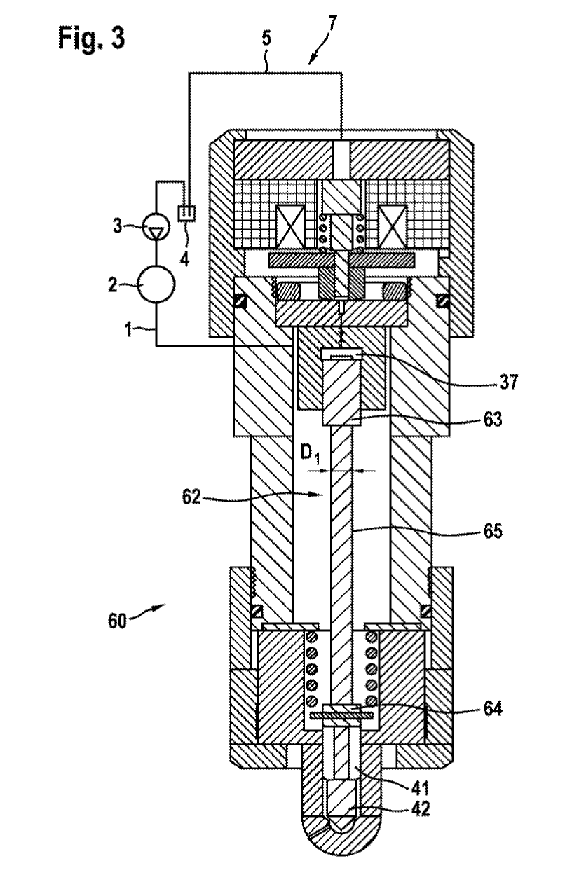

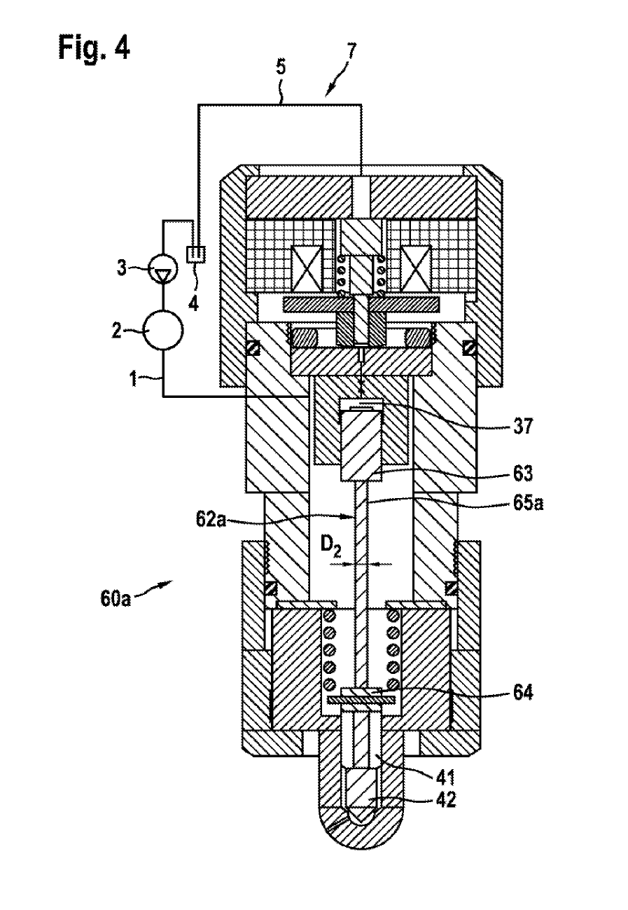

FIGS. 3 and 4 illustrate a third fuel injection valve 60 and a fourth fuel injection valve 60a. The fuel injection valves 60, 60a differ from the fuel injection valves 10, 10a by the use of a valve needle 62, 62a of different construction. Here, the valve needles 62 and 62a are formed in each case in three parts. Each of the valve needles 62, 62a is composed of a standardized upper part 63, which projects into the control chamber 37, and of a standardized lower part 64, which bears the second guide region 41 and the valve tip 42. The upper part 63 and the lower part 64 are connected to one another by means of a central part 65, 65a of cylindrical design. Here, laser welding is preferably used as a connecting technique between the central part 65, 65a and the upper part 63 and also between the central part 65, 65a and the lower part 64.

As can be seen from a juxtaposition of FIGS. 3 and 4, the central part 65 has a larger diameter D₁ than the central part 65a with the diameter D₂. Therefore, the central part 65 also has a larger cross-sectional area A₁ than the central part 65a with the cross-sectional area A₂. While it is provided in the fuel injection valves 10 and 10a that the actuation time t is influenced exclusively by means of a variation of the volume of the control chamber 37, it is the case in the fuel injection valves 60, 60a that the actuation time t is influenced primarily by means of a variation of the diameter D or the cross-sectional area A of the central part 65, 65a. Here, it is advantageously provided that, to reduce the variety of types, the different diameters D of the central parts 65, 65a are provided only in steps, that is to say only a limited number of diameters D is provided or produced for the assembly of fuel injection valves 60, 60a. Here, a coarse adjustment of the actuation times t is realized by means of the variation or selection of the central parts 65, 65a. It is provided here that, if a certain actuation time t can be realized by means of two different diameters D, it is always the smaller diameter D that is used. This has the result that (in relation to the larger diameter D) the volume of the control chamber 37 is smaller in order to compensate for the lower stiffness of the central part 65 which is provided with the relatively small diameter D. The fine adjustment with regard to the actuation time t is now realized, for the selected diameter D, by means of a corresponding shortening or reduction of the length of the central part 65, 65a, such that that region of the upper part 63 which is situated in the valve piece 32 projects to a slightly lesser extent into the control chamber 37.

Here, the ratio of the enlargement of the valve needle stroke ΔH owing to the enlargement of the volume of the control chamber 37 to the shortening of the needle stroke owing to the shortening of the valve needle ΔL can be calculated as follows:

ΔH/ΔL=(E(37)×A(37))/(E(65; 65a)×A(65; 65a)),

Where E(37) is the modulus of elasticity of the fuel in the region of the control chamber 37,

A(37) is the cross-sectional area A in the region of the control chamber 37,

E(65; 65a) is the modulus of elasticity of the portion 65; 65a,

A(65; 65a) is the cross-sectional area A in the region of the portion 65; 65a,

and where, according to the invention, the ratio ΔH/ΔL lies between 100 and 500.

The fuel injection valves 10, 10a and 60, 60a as described may be changed or modified in a variety of ways. In particular, the magnet assembly or the magnet valve 20 may be constructed differently or replaced with a piezo. It is also additionally mentioned that the fuel injection valves 10, 10a, 60, 60a may be designed such that the magnet valve 20 can be closed again already before the injection begins or the through bore 34 is opened up. Variations between successive injections and back pressure dependencies can be reduced in this way.

1. A method for producing a fuel injection valve (10; 10a; 60; 60a), in which method a valve needle (40; 40a; 62; 62a) which closes off a fuel outlet orifice (49) is inserted into an injector housing (11), wherein an opposite end of the valve needle (40; 40a; 62; 62a) from the fuel outlet orifice (49) is guided in a valve piece (32) which has a pressurized, fuel-filled control chamber (37), wherein the control chamber (37) can be closed off, on a side facing away from the valve needle (40; 40a; 62; 62a), by a closing element (23) which, when opened, forms a passage and which is connected at least indirectly to a fuel return line (5) at low pressure, wherein after the opening of the control chamber (37) by means of the closing element (23), fuel volume present in the control chamber (37) flows out through the passage, wherein the valve needle (40; 40a; 62; 62a) moves in a direction of the closing element (23), wherein the fuel outlet orifice (49) is opened, and wherein between the opening of the control chamber (37) and the opening of the fuel outlet orifice (49) there is a delay time (t) due a size of the volume of the control chamber (37) and due to a stiffness of the valve needle (40; 40a; 62; 62a) arising from a modulus of elasticity, a diameter (D) and a length (L) of the valve needle (40; 40a; 62; 62a), the method characterized in that, to attain equal delay times (t) in fuel injection valves (10; 10a; 60; 60a) with injector housings (11) of different lengths and with valve needles (40; 40a; 62; 62a) of different lengths, the volume of the control chamber (37) is adapted such that, to shorten the delay time (t), the volume of the control chamber (37) is decreased and, to lengthen the delay time (t), the volume of the control chamber (37) is increased.

2. The method as claimed in claim 1, characterized in that a geometry of the control chamber (37) in a region in which the valve needle (40; 40a; 62; 62a) is guided is in the form of a cylindrical bore (38) with always the same diameter and always the same depth, and in that the volume of the control chamber (37) is adapted by shortening or lengthening of a portion (39; 39a) of the valve needle (40; 40a; 62; 62a) which is guided in the control chamber (37).

3. The method as claimed in claim 1, characterized in that the valve needle (62; 62a) is composed of at least a standardized first portion (63) arranged in the control chamber (37), which first portion is connected, on a side facing away from the control chamber (37), to a second cylindrical portion (65; 65a), and in that the diameter (D) of the second portion of the valve needle (62; 62a) is varied such that, to shorten the delay time (t), the diameter (D) of the valve needle (62; 62a) is increased and, to lengthen the delay time (t), the diameter (D) of the valve needle (62; 62a) is decreased.

4. The method as claimed in claim 3, characterized in that the diameter (D) of the valve needle (62; 62a) is varied in diameter steps, and in that fine adjustment of the delay time (t) is carried out by adaptation of the volume of the control chamber (37) by varying a length of the second cylindrical portion (65; 65a).

5. The method as claimed in claim 4, characterized in that, taking into consideration a minimum and maximum possible volume of the control chamber (37) and available diameter steps of the valve needle (62; 62a), that the diameter (D) of the valve needles (62; 62a) is selected which leads to a minimum volume of the control chamber (37).

6. The method as claimed in claim 5, characterized in that a ratio of an enlargement of the valve needle stroke ΔH due to an enlargement of the volume of the control chamber (37) to the shortening of the needle stroke due to the shortening of the valve needle ΔL is calculated as follows:
ΔH/ΔL=(E(37)×A(37))/(E(65; 65a)×A(65; 65a)),
where E(37) is the modulus of elasticity of the fuel in the region of the control chamber (37),
A(37) is the cross-sectional area (A) in the region of the control chamber (37),
E(65; 65a) is the modulus of elasticity of the portion (65; 65a),
A(65; 65a) is the cross-sectional area (A) in the region of the portion (65; 65a), and
where the ratio ΔH/ΔL lies between 100 and 500.

7. The method as claimed in claim 3, characterized in that the second portion (65; 65a) of the valve needle (62; 62a) is connected, on an opposite side from the standardized first portion (63), to a standardized third portion (64).

8. The method as claimed in claim 7, characterized in that the connection between the second portion (65; 65a) of the valve needle (62; 62a) and the standardized first portion (63) and between the second portion (65; 65a) of the valve needle (62; 62a) and the third portion (64) is realized by laser welding.

9. A fuel injection valve (10; 10a; 60; 60a) produced according to a method as claimed in claim 1, characterized in that the injector housing (11) of the fuel injection valve (10; 10a; 60; 60a) has a standardized upper part (12) with the closing element (23), and with an actuating mechanism (21, 22) for the closing element (23), and a standardized lower part (14) with a nozzle body (47), and in that a central part (13) which determines the overall structural length of the injector housing (11) is arranged between the upper part (12) and the lower part (14).

10. The fuel injection valve as claimed in claim 9, characterized in that the central part (13) is of annular design.

11. The fuel injection valve as claimed in claim 9, characterized in that the standardized upper part (12) also includes the valve piece (32).

12. The method as claimed in claim 3, characterized in that the connection between the second portion (65; 65a) of the valve needle (62; 62a) and the standardized first portion (63) is realized by laser welding.
